(19) United States
(12) Patent Application Publication
(10) Pub. No.: US 2007/0115600 A1
(43) Pub. Date: May 24, 2007

(54) Apparatus and methods for improved circuit protection from EOS conditions during both powered off and powered on states

(75) Inventors: Mitchel E. Lohr, Windsor, CO (US); Christopher D. Macchietto, Fort Collins, CO (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/285,634

(22) Filed: Nov. 22, 2005

(51) Int. Cl. H02H 3/22

(52) U.S. Cl. 361/111

(57) ABSTRACT

Apparatus and methods for protecting an electronic application circuit from electrical over-stress (EOS) conditions both while the application circuit is powered on and while the application circuit is powered off. In one aspect apparatus is provided that integrates with the application circuit that utilizes an existing clamp circuit to guard against EOS conditions while the application circuit is powered off and while the application circuit is powered on. The apparatus may include a clamp circuit for EOS protection while the application circuit is powered on and may include a band-gap reference voltage source coupled to activate the clamp circuit when the application circuit is powered on.

### BACKGROUND OF THE INVENTION

1. Field of the Invention

The invention relates generally to electrical over-stress (“EOS”) protection of power and ground signals and in particular relates to structures and methods for protecting a circuit from EOS conditions both while the circuit is powered on and while powered off.

2. Discussion of Related Art

Electrical over-stress (EOS) conditions represent a significant source of failures in consumer and other electronic devices. Such failures can be fatal and catastrophic for the circuits of the electronic device. One common EOS condition is an electrostatic discharge (“ESD”) in which a discharge voltage directs substantial current through portions of a circuit not adapted for such high current flows. Such ESD incidents are common in many electronic devices including, for example, consumer electronics used in environments where static electricity buildups may cause discharges within the consumer electronic device.

A particular problem known as “latch up” arises in EOS conditions in CMOS electronic circuits due to the nature of CMOS circuit designs. In general, dynamic latch up of a CMOS device may occur when a device is subjected to a “spike” (an EOS condition) on its Vdd power supply signal while the device is operating. Such a latch up condition of a CMOS device often renders the device unusable.

In general, present techniques and structures provide ESD protection circuits associated with signals paths of a circuit design. In particular, clamp circuits are often provided that are activated when the circuit is powered off but exposed to an ESD situation (i.e., a Vdd spike condition). These clamp circuits activate transistor switches from the spiked voltage applied to Vdd and shunt the generated current harmlessly away from the functional elements of the circuit being protected. For example, the generated current from an EOS condition may be switched and shunted through a low impedance load to ground—e.g., shunted to a circuit path having lower impedance as compared to the powered off operational circuit.

However, present ESD (EOS) protection circuits do not provide a complete solution to the problem. The clamp circuits generally used for such protection only protect the operational circuit while it is in a powered off state. If the circuit to be protected is powered on, present clamp circuit designs may present a higher impedance conductive path as compared to the powered on (operating) circuit to be protected. Thus, current EOS/ESD protection circuit designs do not protect a powered up, operational circuit from EOS problems.

It is therefore evident from the above discussion that a need exists for improved circuits and methods for protecting a circuit from EOS conditions both in an operational mode and in a powered down non-operational mode.

### SUMMARY OF THE INVENTION

The present invention solves the above and other problems, thereby advancing the state of the useful arts, by providing circuit structures and systems for protecting an application circuit from EOS conditions both while powered off and while powered on. A standard ESD clamp circuit provides EOS protection for an associated application circuit while the application circuit is powered off. The clamp circuit is coupled to a signal pad on which an application circuit receives an external voltage source signal (e.g., a power supply voltage signal or other power source related signal). The clamp circuit may also be coupled to a clamp actuator circuit in accordance with feature and aspects hereof to provide EOS protection for the application circuit while the application circuit is powered on. The clamp actuator circuit may comprise a comparator circuit that compares the external voltage source signal on which an EOS condition may arise to a reference voltage source signal. If the external source voltage level rises above the reference voltage level, an EOS condition is detected and the comparator circuit applies an actuation signal to the clamp circuit to thereby actuate the clamp circuit and protect the application circuit. In one aspect, the reference source may be a bandgap reference voltage source. Charge pump circuits may be applied to adapt the bandgap reference voltage level to a level appropriate to sense the EOS condition and appropriate to the nominal voltage level of the external voltage source signal.

A first feature hereof provides apparatus in an electronic application circuit for protecting the application circuit from electrical over-stress (“EOS”) conditions, the apparatus comprising: a signal pad adapted to receive an external power signal and adapted to route the external power signal for use within the application circuit; a clamp circuit coupled to the signal pad and adapted to protect the application circuit from EOS conditions applied to the signal pad while the application circuit is powered off; and a clamp actuator circuit coupled to the clamp circuit to actuate the clamp circuit while the application circuit is powered on and in response to an EOS condition.

Another aspect hereof further provides that the clamp actuator circuit further comprises: a voltage source independent of the external power signal adapted to generate a reference voltage signal; and a comparator coupled to the precision voltage source and coupled to the external power signal and adapted to generate a signal to actuate the clamp circuit in response to an EOS condition detected by comparing the voltage of the external power signal and the reference voltage signal.

Another aspect hereof further provides that the voltage source further comprises: a bandgap reference voltage source adapted to generate the reference voltage signal.

Another aspect hereof further provides that the voltage source further comprises: a charge pump coupled between the bandgap reference voltage source and the comparator to adapt the reference voltage signal level applied to the comparator to a level suitable to effectuate actuation of the clamp circuit by signal generated by the comparator.

Another aspect hereof further provides that the reference voltage signal level is higher than the nominal operating voltage level applied to the signal pad by the external power signal.

Another aspect hereof further provides that the reference voltage signal level is higher than the testing operating voltage level applied to the signal pad by the external power signal during high temperature operating life test procedures used with the application circuit.

Another feature hereof provides an application circuit comprising: a plurality of signal pads each coupled to a corresponding external voltage source signal for use within the application circuit; a plurality of clamp circuits each coupled to a corresponding signal pad and adapted to protect a portion of the application circuit associated with the corresponding signal pad from electronic over-stress (“EOS”) conditions applied to the corresponding signal pad while the application circuit is powered off; a reference voltage source independent of the external voltage source for generating a reference voltage signal; and a plurality of clamp actuator comparator circuits each coupled to the reference voltage source and each coupled to the external voltage source and each coupled to one or more corresponding clamp circuits of the plurality of clamp circuits to actuate the one or more corresponding clamp circuits while the application circuit is powered on and in response to detecting that the voltage level of the external voltage source exceeds the voltage level of the reference voltage source.

Another aspect hereof further provides that the reference voltage is further adapted to generate a plurality of reference voltage signals having different voltage levels, and provides that each clamp actuator comparator circuit is coupled a corresponding reference voltage signal of the plurality of reference voltage signals.

Another aspect hereof further provides that the reference voltage source further comprises: a bandgap reference voltage source for generating a bandgap reference voltage signal; and a plurality of charge pump circuits each coupled to receive the bandgap reference voltage signal and each adapted to generate a corresponding reference voltage signal therefrom.

Another feature hereof provides a method operable in an application circuit to protect the application circuit from electrical over-stress (“EOS”) conditions wherein the application circuit includes a signal pad adapted to receive an external voltage signal from an external voltage source and wherein the application circuit includes a clamp circuit coupled to the signal pad, the method comprising: actuating the clamp circuit while the application circuit is powered off by a voltage level applied to the clamp circuit as a result of the EOS condition; and actuating the clamp circuit while the application circuit is powered on by operation of the clamp actuator circuit.

Another aspect hereof further provides that the step of actuating the clamp circuit while the application circuit is powered on further comprises: applying a first voltage level from the signal pad to a comparator; applying a reference voltage level from a reference voltage source to the comparator; comparing the first voltage level to the reference voltage level; and generating an actuating signal applied to the clamp circuit when the first voltage level exceeds the reference voltage level.

Another aspect hereof further provides that the step of applying a reference voltage level further comprises: generating the reference voltage level as a bandgap reference voltage level using a bandgap reference voltage source.

Another aspect hereof further provides that the step of applying a reference voltage level further comprises: altering the bandgap reference voltage level using a charge pump circuit to generate the reference voltage level.

### BRIEF DESCRIPTION OF THE DRAWINGS

FIG. 1 is a block diagram of an exemplary application circuit incorporating features and aspects hereof to protect the circuit against EOS related damage both while powered off and while powered on.

FIG. 2 is a circuit diagram of an exemplary clamp circuit that may be used in conjunction with features and aspects hereof.

FIG. 3 is a block diagram of an exemplary reference voltage source for use in conjunction features and aspects hereof.

FIG. 4 is a block diagram of another exemplary reference voltage source configured to provide multiple reference voltage level signals for use in conjunction features and aspects hereof.

FIG. 5 is a block diagram of another exemplary application circuit incorporating features and aspects hereof to protect the circuit against EOS related damage both while powered off and while powered on.

FIG. 6 is a block diagram of another exemplary application circuit incorporating features and aspects hereof to protect the circuit against EOS related damage both while powered off and while powered on.

### DETAILED DESCRIPTION OF THE DRAWINGS

FIG. 5 is a block diagram of an exemplary apparatus 500 in which an application circuit 512 is coupled to an external voltage source 502 and is enhanced in accordance with features and aspects hereof to provide EOS protection both while the application circuit 512 is powered off and while the application circuit 512 is powered on. Application circuit 512 may include a signal pad 510 adapted to receive an external voltage level from the external voltage source 502. The signal pad 510 may be, in turn, coupled to application functional circuits 508 to provide power to perform desired logic functions within the application circuit 512. Further, clamp circuit 504 may be coupled to signal pad 510 to protect application functional circuits 508 from potential damage due to EOS conditions associated with the external voltage level provided by external voltage source 502. As is generally known in the arts, clamp circuit 504, per se, serves to protect application functional circuits 508 of application circuit 512 while application circuit 512 is powered off. In general, clamp circuit 504 assures that excess current is drained through a lower impedance path of clamp circuit 504 rather than potentially damaging application functional circuits 508 of application circuit 512.

As noted above, clamp circuit 504, per se, as currently practiced in the art does not guard application functional circuits 508 from EOS conditions while the application circuit 512 is powered on. As presently practiced in the art, no mechanism devoid of features and aspects hereof assures that the clamp circuit 504 will be actuated while the application circuit 512 is powered on. In accordance with features and aspects hereof, a clamp actuator circuit 506 may be coupled to clamp circuit 504 to actuate clamp circuit 504 in response to sensing an EOS condition on the signals generated by external voltage source 502. In response to sensing such an EOS condition on the external voltage source signal path, clamp actuator 506 assures that clamp circuit 504 will be actuated even while application circuit 512 is powered on and operating. Thus, apparatus 500 provides protection of application circuit 512 from damage due to EOS conditions both while application circuit 512 is powered off and while application circuit 512 is powered on.

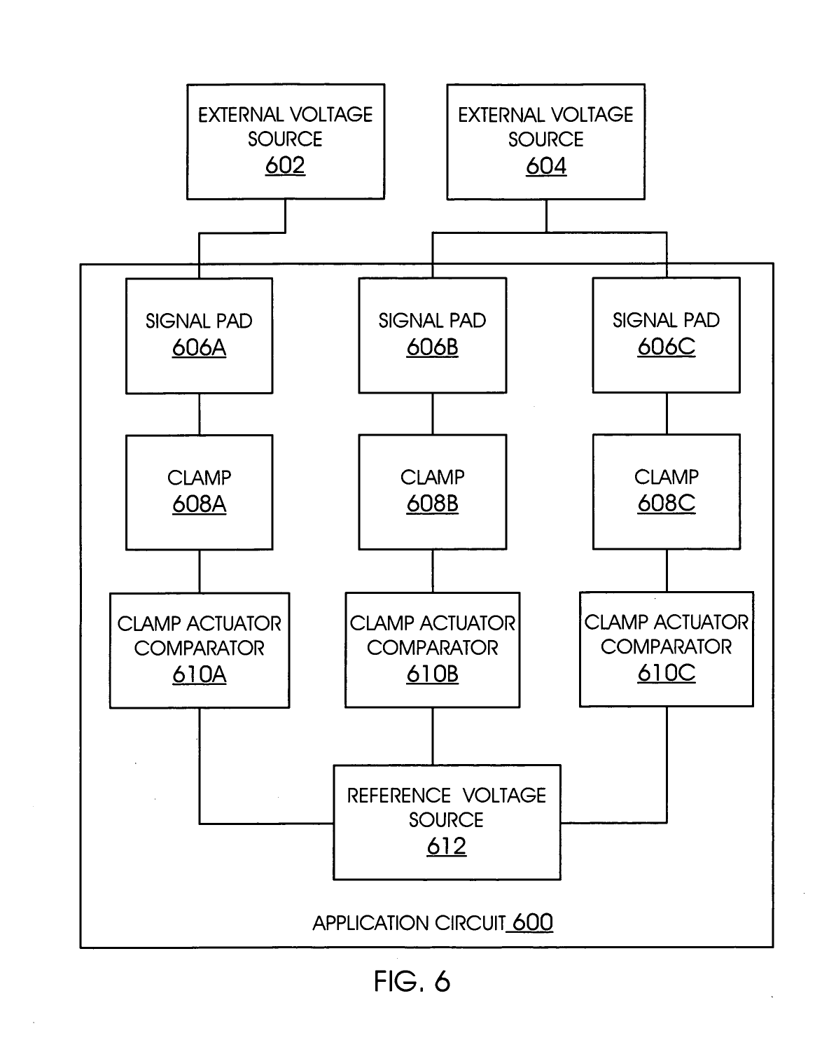

FIG. 6 shows a more extensive exemplary system in which application circuit 600 is protected from EOS conditions both while powered off and while powered on using multiple external voltage source signals. A first external voltage source 602 and a second external voltage source 604 each supply distinct external voltage signals to application circuit 600. As generally known in the art, external voltage sources 602 and 604 may be independent voltage sources (e.g., independent power supplies), or may be distinct voltage levels supplied from a common external voltage source (e.g., a single power supply providing multiple voltage levels). Signal pad 606A receives a first external voltage level signal supplied by external voltage source 602. Clamp circuit 608A provides protection for signal pad 606A and application circuitry (not shown) coupled thereto. Signal pads 606B and 606C each receive a second external voltage level signal from external voltage source 604 for application to associated application circuitry (not shown). Clamp circuits 608B and 608C each protect application circuitry coupled to signal pads 606B and 606C, respectively, to guard against damage from EOS conditions.

As noted above, as presently practiced in the art, clamp circuits 608A, 608B, and 608C protect associated signal pads 606A, 606B, and 606C and associated application circuitry only while application circuit 600 is powered off. In accordance with features and aspects hereof, clamp actuator comparators 610A, 610B, and 610C are coupled to associated clamp circuits 608A, 608B, and 608C, respectively, to guard against damage from EOS conditions while application circuit 600 is powered on. In general, each clamp actuator comparator circuit 610A-610C is operable to actuate its associated clamp circuit 608A-608C, respectively, in response to sensing or detecting that the external voltage level applied to the corresponding signal pads 606A-606C exceeds the corresponding reference voltage level supplied by a reference voltage source 612.

The reference voltage source 612 may supply a common reference voltage level to each of the clamp actuator comparator circuits 610A-610C. Alternatively, reference voltage source 612 may provide distinct reference voltage level signals appropriate for each clamp actuator comparator circuit 610A-610C. Further, reference voltage source 612 may provide multiple distinct reference voltage level signals by utilizing multiple charge pump circuits coupled to a common bandgap reference source as discussed in further detail herein below.

FIGS. 5 and 6 are intended merely as representative of exemplary systems and applications embodying features and aspects hereof. Those of ordinary skill in the art will readily recognize numerous equivalent system configurations and topologies wherein features and aspects hereof guard an application circuit from damage due to EOS conditions both with the application circuit is powered off and while powered on.

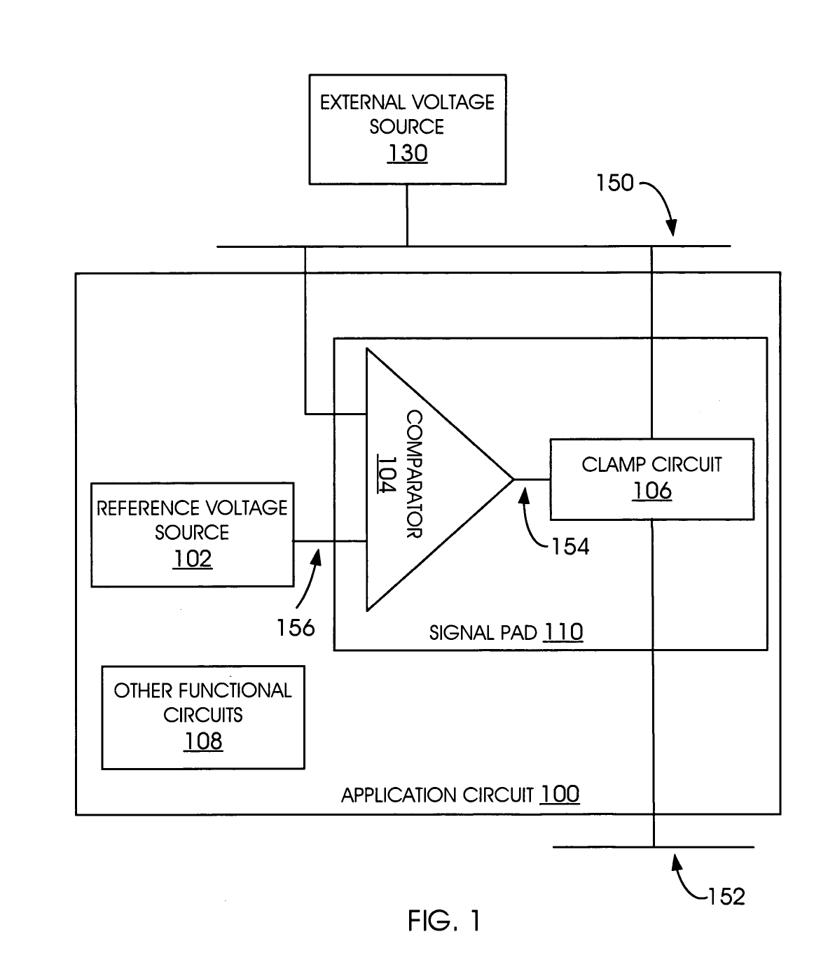

FIG. 1 shows an exemplary application circuit enhanced in accordance with features and aspects hereof to provide protection of functional circuits 108 from damage due to EOS conditions arising on signal paths 150 adapted to receive an external voltage level signal from an external voltage source 130. Signal pad 110 within application circuit 100 is adapted to receive the intended external voltage level signal from an external voltage source 130 via conductive path 150. Associated with signal pad 110, clamp circuit 106 is configured to protect functional circuits 108 of the application circuit 110 from EOS conditions while the application circuit 100 is powered off. Path 152 is typically a ground potential of the associated power signal on path 150. Clamp circuit 106 is actuated while the application circuit 110 is powered off to shunt any damaging current from an EOS condition to the current sink of ground signal path 152.

In accordance with features and aspects hereof, comparator circuit 104 serves to actuate clamp circuit 106 when application circuit 100 is powered on. Comparator 104 generates an actuation signal on path 154 for application to clamp circuit 106 to actuate clamp circuit 106 in response to sensing an EOS condition on external voltage level signal path 150. Comparator circuit 104 receives the present signal voltage level on path 150 and compares that signal voltage level to a reference voltage level signal on path 156 generated by reference voltage source 102. When comparator circuit 104 senses that the present external voltage level signal on path 150 exceeds the reference voltage level signal on path 156, comparator circuit 104 actuates clamp circuit 106 by generating a signal on path 154.

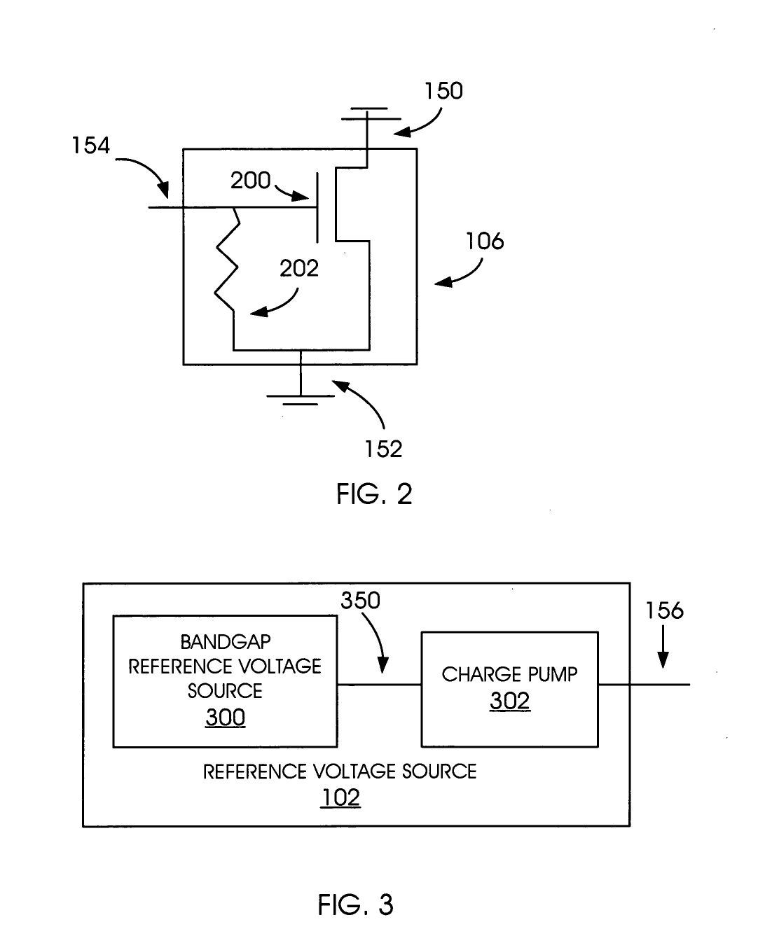

FIG. 2 is a block diagram showing additional details of a typical clamp circuit as may be incorporated in common electronic design libraries. Clamp circuit 106 may be an exemplary grounded gate NMOS device as may currently be applied to protect application circuitry from damage due to electrostatic discharge (ESD) currents. As normally applied for such ESD protection, no stimulus signal need be applied to the gate node of transistor 200 via path 154. Rather, while the associated application circuit is powered off, an EOS condition sensed on path 150 may actuate transistor 200 through resistive load 202. Clamp circuit 106 is often referred to as a grounded-gate NMOS transistor (“GGNMOS”). As generally known in the art, so called “impact ionization” at the drain-to-substrate junction forms, in effect, a parasitic NPN transistor to turn on (an NMOS transistor formed as drain=N, substrate=P, and source=N). When this parasitic NPN transistor turns on, it temporarily clamps the drain to the source. This phenomenon is often referred to as “snapback”. Thus, when powered off, the snapback effect causes the transistor to turn on and shunt damaging current from an EOS event to the ground level current sink on path 152. Such circuit structures and their operation are well known to those of ordinary skill in the art as suitable for protection of an application circuit from ESD damage while the circuit is powered off.

In accordance with features and aspects hereof, an actuator circuit such as comparator circuit 104 of FIG. 1, may actuate the gate node of transistor 200 in response to sensing an EOS condition on signal path 150. Thus, features and aspects hereof provide actuation of the clamp circuit 106 in response to sensing an EOS condition while the application circuit utilizing the clamp circuit is powered on.

Those of ordinary skill in the art will readily recognize a wide variety of similar clamp circuit structures in which a transistor gate node may be activated while the application circuit is powered off in response to sensing an EOS condition. Therefore, numerous clamp circuit structures may be suitable for application in accordance with features and aspects hereof to provide actuation of the clamp circuit while the associated application circuit is powered on. FIG. 2 is therefore intended merely as exemplary of one possible clamp circuit useful in accordance with features and aspects hereof to provide EOS protection while an associated application circuit is powered on.

FIG. 3 provides additional details of an exemplary reference voltage source 102 as noted above in FIG. 1. Reference voltage source 102 may include a bandgap reference voltage source 300 that produces a bandgap reference voltage level signal on path 350. Charge pump circuit 302 receives the bandgap reference voltage level signal on path 350 and adapts the signal to provide a desired reference voltage level on path 156. As noted above, the reference voltage level so generated and applied to path 156 may be received as an input to a comparator clamp actuator circuit configured to actuate an associated clamp circuit in response to sensing an EOS condition as exceeding the threshold voltage level of the reference voltage applied to path 156.

Those of ordinary skill in the art will readily recognize standard analog circuit components useful for the bandgap reference voltage source 300 and charge pump 302. Such circuits are well known to those of ordinary skill in the art and readily available as elements in electronic design libraries readily available to those of ordinary skill and the art.

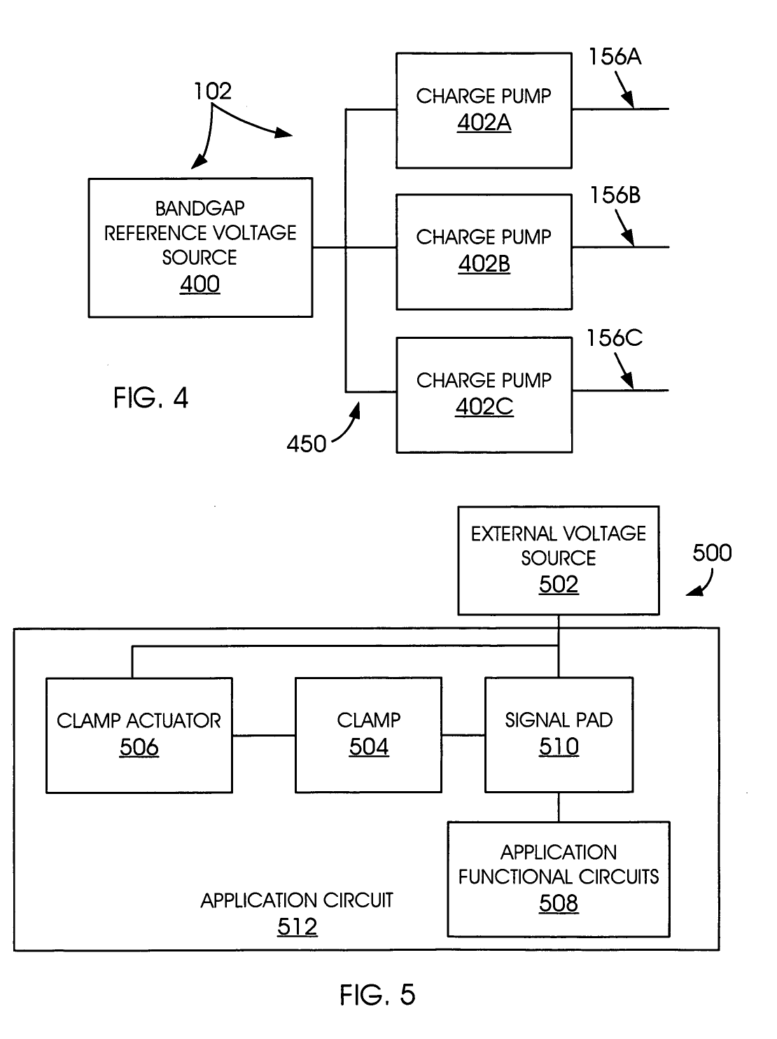

FIG. 4 shows an alternative exemplary embodiment of a reference voltage source 102 as noted above in FIG. 1. Sensing of an EOS condition may be defined differently for different external voltage level signals. Reference voltage source 102 of FIG. 4 is therefore configured to generate a plurality of reference voltage level signals applied to paths 156A, 156B, and 156C. A single bandgap reference voltage source 400 generates a bandgap reference voltage level applied to path 450. Each of multiple charge pump circuits 402A, 402B, and 402C may receive the bandgap reference voltage level signal on path 450 and may generate a corresponding reference voltage level applied to its corresponding signal path 156A, 156B, and 156C. Each reference voltage level on path 156A-156C may then be applied as an input to a corresponding clamp actuator comparator circuit to aid in detecting an EOS condition at a corresponding signal pad adapted to receive an external voltage level signal.

Those of ordinary skill in the art will readily recognize commercially available circuit designs for providing bandgap reference voltage source 400 and associated charge pump circuits 402A-402C.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

What is claimed is:

1. Apparatus in an electronic application circuit for protecting the application circuit from electrical over-stress (“EOS”) conditions, the apparatus comprising:
a signal pad adapted to receive an external power signal and adapted to route the external power signal for use within the application circuit;
a clamp circuit coupled to the signal pad and adapted to protect the application circuit from EOS conditions applied to the signal pad while the application circuit is powered off; and
a clamp actuator circuit coupled to the clamp circuit to actuate the clamp circuit while the application circuit is powered on and in response to an EOS condition.

2. The apparatus of claim 1 wherein the clamp actuator circuit further comprises:
a voltage source independent of the external power signal adapted to generate a reference voltage signal; and
a comparator coupled to the precision voltage source and coupled to the external power signal and adapted to generate a signal to actuate the clamp circuit in response to an EOS condition detected by comparing the voltage of the external power signal and the reference voltage signal.

3. The apparatus of claim 2 wherein the voltage source further comprises:
a bandgap reference voltage source adapted to generate the reference voltage signal.

4. The apparatus of claim 3 wherein the voltage source further comprises:
a charge pump coupled between the bandgap reference voltage source and the comparator to adapt the reference voltage signal level applied to the comparator to a level suitable to effectuate actuation of the clamp circuit by signal generated by the comparator.

5. The apparatus of claim 4 wherein the reference voltage signal level is higher than the nominal operating voltage level applied to the signal pad by the external power signal.

6. The apparatus of claim 4 wherein the reference voltage signal level is higher than the testing operating voltage level applied to the signal pad by the external power signal during high temperature operating life test procedures used with the application circuit.

7. An application circuit comprising:
a plurality of signal pads each coupled to a corresponding external voltage source signal for use within the application circuit;
a plurality of clamp circuits each coupled to a corresponding signal pad and adapted to protect a portion of the application circuit associated with the corresponding signal pad from electronic over-stress (“EOS”) conditions applied to the corresponding signal pad while the application circuit is powered off;
a reference voltage source independent of the external voltage source for generating a reference voltage signal; and
a plurality of clamp actuator comparator circuits each coupled to the reference voltage source and each coupled to the external voltage source and each coupled to one or more corresponding clamp circuits of the plurality of clamp circuits to actuate the one or more corresponding clamp circuits while the application circuit is powered on and in response to detecting that the voltage level of the external voltage source exceeds the voltage level of the reference voltage source.

8. The application circuit of claim 7
wherein the reference voltage is further adapted to generate a plurality of reference voltage signals having different voltage levels, and
wherein each clamp actuator comparator circuit is coupled a corresponding reference voltage signal of the plurality of reference voltage signals.

9. The application circuit of claim 8 wherein the reference voltage source further comprises:
a bandgap reference voltage source for generating a bandgap reference voltage signal; and
a plurality of charge pump circuits each coupled to receive the bandgap reference voltage signal and each adapted to generate a corresponding reference voltage signal therefrom.

10. A method operable in an application circuit to protect the application circuit from electrical over-stress (“EOS”) conditions wherein the application circuit includes a signal pad adapted to receive an external voltage signal from an external voltage source and wherein the application circuit includes a clamp circuit coupled to the signal pad, the method comprising:
actuating the clamp circuit while the application circuit is powered off by a voltage level applied to the clamp circuit as a result of the EOS condition; and
actuating the clamp circuit while the application circuit is powered on by operation of the clamp actuator circuit.

11. The method of claim 10 wherein the step of actuating the clamp circuit while the application circuit is powered on further comprises:
applying a first voltage level from the signal pad to a comparator;
applying a reference voltage level from a reference voltage source to the comparator;
comparing the first voltage level to the reference voltage level; and
generating an actuating signal applied to the clamp circuit when the first voltage level exceeds the reference voltage level.

12. The method of claim 11 wherein the step of applying a reference voltage level further comprises:
generating the reference voltage level as a bandgap reference voltage level using a bandgap reference voltage source.

13. The method of claim 12 wherein the step of applying a reference voltage level further comprises:
altering the bandgap reference voltage level using a charge pump circuit to generate the reference voltage level.
